(19) United States
(12) Patent Application Publication
(10) Pub. No.: US 2025/0113801 A1
(43) Pub. Date: Apr. 10, 2025

(54) Attachment for Bicycle for Exercising a Dog

(71) Applicant: Douglas Jay Wolf, Ventura, CA (US)

(72) Inventor: Douglas Jay Wolf, Ventura, CA (US)

(21) Appl. No.: 18/377,809

(22) Filed: Oct. 8, 2023

(51) Int. Cl. A01K 15/02; A01K 27/00; B62J 50/00

(52) U.S. Cl. CPC A01K 1/04; B62J 50/00

(57) ABSTRACT

The latest innovation in the world of pet accessories is the introduction of a remarkable attachment for bicycles. Specifically designed to facilitate safe and efficient exercise for dogs while biking, this attachment is a game-changer for pet owners who enjoy riding and want to share their passion with their furry friends. The assembly process is straightforward and hassle-free, and the attachment can be conveniently folded for storage. Its construction is of superior quality and durability, ensuring that it can withstand the energetic movements of even large and boisterous dogs. This attachment is a must-have for any pet owner looking to combine their love of cycling with their love for their four-legged companion.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention is generally directed to an exercising device for dogs which is attached to a bicycle, tricycle or similar moving vehicle enabling the user to operate the vehicle and exercise the dog in a safe and efficient manner.

### Description of the Related Art

In recent years, bicycling has gained more popularity as a form of exercise and many people have shifted from activities such as running or swimming. As people age, they tend to prefer cycling due to its low-impact potential for aerobic workouts. However, this can pose a problem for individuals who used to combine their exercise routine with walking their dog.

While it may seem like a good idea to ride a bike while holding a dog on a leash, it is not safe. Dogs may become excited and run between the wheels after a cat or squirrel or become entangled in the pedals. Moreover, a dog's movement at the end of a leash can destabilize the rider.

Although there are leash attachments designed for cyclists, these come with two major issues. Firstly, they are often placed high on the bicycle, creating a long moment arm which can cause the rider to topple. Secondly, the attachment extends to one side of the bicycle, allowing the dog to torque the rider. This limits the practicality of the attachment to small or low-energy dogs. Larger dogs are at an increased risk of causing accidents, while small dogs are also vulnerable to getting caught in the pedals or rear wheel spokes.

Therefore, it is important for individuals who enjoy cycling and walking their pets to find alternative solutions that prioritize both their safety and their pet's well-being. It is recommended to take dogs for a walk before or after cycling, or to use a dog-specific trailer or a basket that can be attached to the bicycle. This ensures that both the rider and their furry friend can enjoy the exercise routine without any potential risks.

Although the prior art may be adequate for its intended purposes, a need still exists for a durable attachment for bicycles that covers traditional devices and provides reliable, high-quality, and durable attachment. The current device aims to provide a framework for a bicycle where a dog can be protected while the owner operates the bicycle and exercises the dog.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of attachment for bicycles for exercising dogs.

Another object of the present invention is to provide a bracket that is adapted to be attached to the bicycle.

Another object of this invention is to provide a new and improved assembly wherein the bracket fits the dog and attaches to the dog's harness with two bungee cords.

It is an object of the invention to provide a foldable assembly that can be folded once not in use.

Yet another object of the present invention is to provide a structure that is relatively inexpensive to produce so that ownership is available to a substantial majority of dog owners.

It is a further aspect of the present invention to provide a new and improved assembly that is durable and reliable and can sustain its effectiveness after multiple and consistent uses.

Thus, it is the objective to provide a yoke-style design for better control and ease. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the complete assembly attached to the bicycle showing my new design;

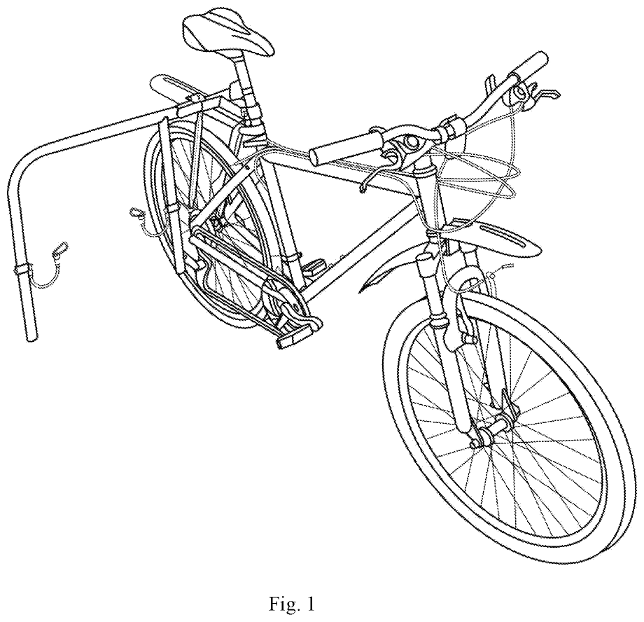

FIG. 2 shows the folded view as per preferred embodiments of the invention.

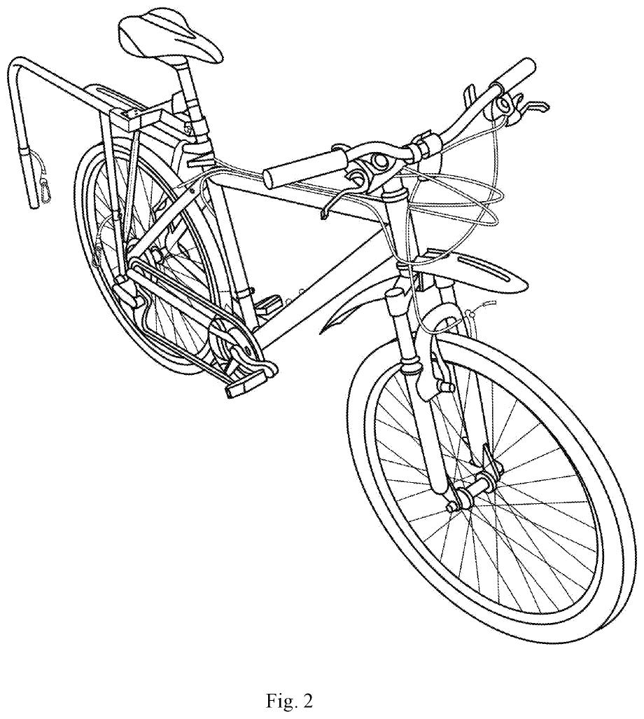

FIG. 3 shows the perspective use of assembly as per preferred embodiments of the invention.

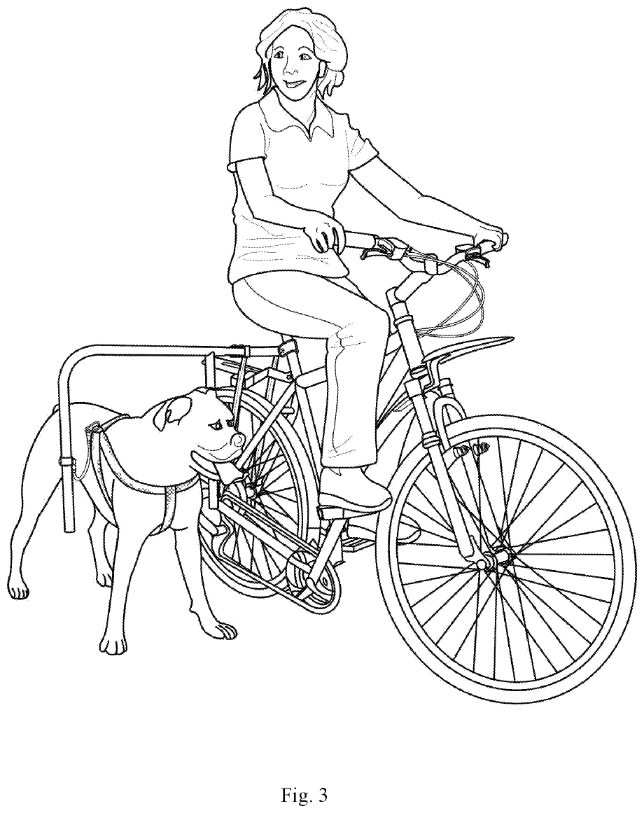

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

With increased interest in exercise in general, and the aging of the population to the point at which running becomes increasingly less healthy, bicycling is a natural substitute. For those who currently walk or in the past have walked pets, the need to attach the animal to the bicycle is manifest. Although designed primarily for dogs, cats, pet pigs, and other animals could be attached as well. When used with dogs, even energetic dogs weighing 200 pounds, the design of the current invention is such that the stability of the bicycle is not unduly compromised and by exercising due caution a safe ride can be had. For a person who rides a lot and takes a dog or other pet along, a restraint of this type is a must, making it safer for pedestrians, cyclist, and the dog. Thus, the present invention discusses an attachment for bicycles that can be attached easily, allowing pet owners to take their pets along while they are bicycling.

The main part of the invention is the elongated framework preferably made of lightweight, plastic, steel or aluminum tubing, steel, plastic or any other suitable material and capped on the ends as indicated. The bar defines an angled arc is a joint at the rear seat and stays just side of the rear wheel axle. The endcaps are preferably molded plastic. The bar has two ends wherein one end is connected to the bicycle and the second end extends to the opposite side. Both ends are provided with bungee cords that can be attached to the dog's collar for easier to use, comfortable and aesthetically more appealing.

The leash is attached to the bracket by any suitable means. In the illustrated embodiment, a bungee cord is used that can terminate in a quick-release fastener, engageable with a corresponding termination on the leash. A hand which also has a quick-release coupling may be provided to provide a smooth transition from bicycling to walking without interrupting control over the animal.

When embarking on a cycling adventure with your canine companion, prioritizing safety is of utmost importance. It is crucial that your dog is positioned on the right side of the bike, away from the flow of traffic, so that you can closely monitor their actions. It is essential to bear in mind that your dog cannot steer or control the bicycle, and you must be prepared to hit the brakes in case of an emergency. It is strongly recommended that you avoid using a leash as it can cause your dog to dart in front of the bike, leading to a potentially fatal accident. If your dog is positioned behind you, they may have the leverage to steer the bike, which is also dangerous. To prevent this, it is best to place your dog on the side of the bike where you have complete control. Additionally, the bar that goes over your dog and around their side should be long enough to provide adequate protection in case of a fall or crash. This approach ensures that both you and your furry friend can exercise in a safe and responsible manner. While walking your dog is an excellent form of exercise, it may not be enough for larger breeds such as Labrador Retrievers. Hence, opting for this well-thought-out and cost-effective solution is a logical choice to meet your exercise needs while bonding with your pet.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An attachment for bicycles for exercising dogs comprising:
A metal elongated bar;
Two sidebars extending from ends of the elongated bar; and,
Bungee cord attached to opposite ends.
As per claim 1, the attachment forms a yoke-style arc architecture for better control of the dog.
As per claim 1, the attachment is collapsible and can be closed once not in use.
As per claim 1, the attachment fits comfortably around the dog and can be attached to the dog's harness.
As per claim 1, the attachment fits around the dog's harness with attachment means preferably bungee cords.
